(19) United States
(12) Patent Application Publication
(10) Pub. No.: US 2024/0361748 A1
(43) Pub. Date: Oct. 31, 2024

(54) PRINT ACCURACY SCORE BASED ON 3D METROLOGY DATA

(71) Applicant: Stratasys, Inc., Eden Prairie, MN (US)

(72) Inventors: James S. Page, Berkeley, CA (US); Benjamin Semerjian, Portland, OR (US)

(21) Appl. No.: 18/307,455

(22) Filed: Apr. 26, 2023

(51) Int. Cl. G05B 19/4099

(52) U.S. Cl. CPC G05B 19/4099; G05B 2219/49023

(57) ABSTRACT

A method includes determining a plurality of distances between a representation of the part that is based on three-dimensional metrology data and a three-dimensional model of the part and applying each distance to a function to produce a plurality of function results. A single score is formed from the plurality of function results. The single score is displayed and at least one of the following is performed: comparing the single score to a single score of another part to determine whether changes made to a manufacturing process result in more accurate parts; determining whether the part is constructed accurately enough to warrant constructing additional copies of the part; or using the single score to determine whether the part is constructed accurately enough to warrant physical inspection.

### BACKGROUND

3D printers build three-dimensional parts layer-by-layer, or in continuous layers, from one or more part materials. The resulting printed parts often have complex shapes. In order for a final printed part to be acceptable, the dimensions and overall geometry of the various shapes in the part must meet expectations.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes determining a plurality of distances between a representation of the part that is based on three-dimensional metrology data and a three-dimensional model of the part and applying each distance to a function to produce a plurality of function results. A single score is formed from the plurality of function results. The single score is displayed and at least one of the following is performed: comparing the single score to a single score of another part to determine whether changes made to a manufacturing process result in more accurate parts; determining whether the part is constructed accurately enough to warrant constructing additional copies of the part; or using the single score to determine whether the part is constructed accurately enough to warrant physical inspection.

In accordance with a further embodiment, three-dimensional metrology data is obtained from a part constructed using a model of the part, build parameters for the part and a material for the part. A plurality of points determined from the three-dimensional metrology data are registered to corresponding points of a model of the part. For each point in the plurality of points determined from the three-dimensional metrology data, a distance from the point to the corresponding point on the model of the part is determined and each distance is scaled based on a tolerance value for the part to produce a plurality of scaled values. The plurality of scaled values are used to produce a score for the part and the score is displayed. A second part is built using a model for the second part, build parameters for the second part and a material for the second part wherein at least one of the model for the second part, the build parameters for the second part and the material for the second part is respectively different from the model of the part, the build parameters for the part and the material for the part. Three-dimensional metrology data is obtained from the second part and a plurality of points determined from the three-dimensional metrology data for the second part are registered to corresponding points of the model of the second part. For each point in the plurality of points determined from the three-dimensional metrology data for the second part, a distance from the point to the corresponding point on the model of the second part is determined and each distance is scaled based on a tolerance value for the second part to produce a plurality of scaled values for the second part. The plurality of scaled values for the second part are used to produce a score for the second part and the score for the second part is displayed.

In accordance with a still further embodiment, a method includes setting a tolerance for a part based on an identifier of a machine used to form the part and obtaining three-dimensional metrology data from the part. For each of a plurality of points associated with the metrology data, a distance between the point and an expected location for the point is determined to produce a plurality of distances. Each distance in the plurality of distances is modified using the tolerance to form a plurality of modified distances. The modified distances are used to form an accuracy score for the part.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method of determining whether a part is manufactured well enough to warrant physical inspection.

FIG. 2 is a block diagram of a system for performing the methods of FIGS. 1 and 3.

FIG. 3 is a method of determining whether changes to build parameters result in better made parts.

FIG. 4 is a method of determining a single quality score for a part.

FIG. 5 is a method of determining a part tolerance.

FIG. 6 is a graph of Point Accuracy Scores as a function of average point error per tolerance.

FIG. 7 is an example of a user interface for a first build of a part.

FIG. 8 is an example of a user interface for a second build of the part of FIG. 7.

FIG. 9 is a block diagram of a computing device used as a workstation in the various embodiments.

### DETAILED DESCRIPTION

Under the prior art, determining whether a 3D-printed part is satisfactory involves performing a physical inspection of the part in which the dimensions of different portions of the part are physically measured. Because many 3D printed parts have complex geometries and often shrink inconsistently based on direction, such detailed physical measurements are time consuming and labor intensive. Embodiments described below provide a fast mechanism for evaluating the accuracy of a part. Specifically, a 3D scan of the part is used to produce a single score for the part, known as a Print Accuracy Score (PAS). Using this single score, it is possible to determine whether the part is built well enough to warrant a physical inspection of the part or is built accurately enough to warrant building additional copies of the part. If a part has a low Print Accuracy Score, the part can be discarded and the design of the part and/or the build parameters used to build the part can be altered to try to improve the accuracy of the part without having to wait for a detailed physical measurement of the part. This quick assessment of the part's accuracy speeds up the iterative process used to find an acceptable part design and an acceptable set of build parameters.

The single score provided in the embodiments below also provides an effective way to compare the build quality of two parts. In particular, the single score is based on a function that is smooth, differentiable and monotonically decreasing with increasing average error across the part. As a result, parts with lower average error will always have a higher score than parts with higher average error. This makes it easier to compare parts built before a build parameter change, part model change and/or material change to parts built after the build parameter change, part model change and/or material change. Specifically, when a part has a better score after the build parameters/part model/material are changed, it can be assured that the changes resulted in a part with lower average errors. As a result, it is possible to use the single score described below to speed up the iterative process of setting part designs, materials and build parameters for a part.

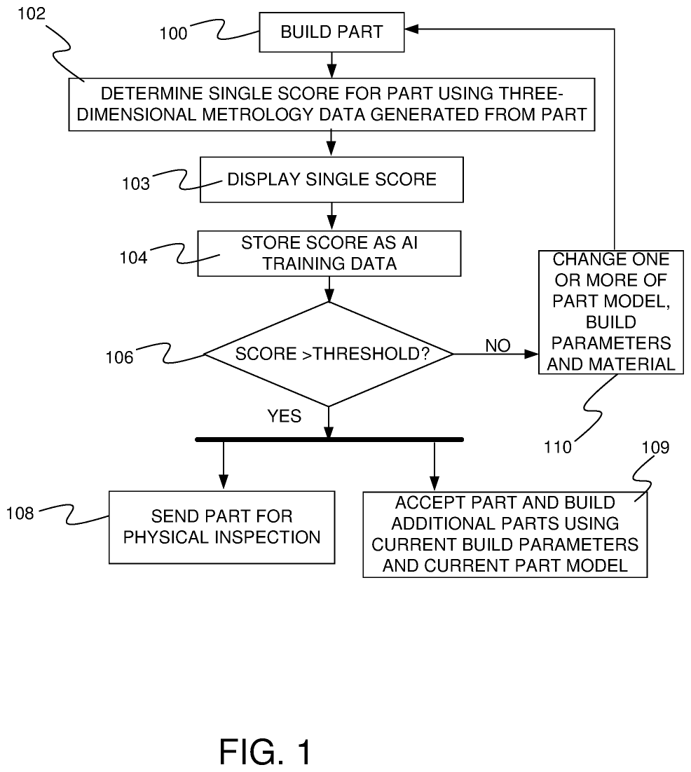

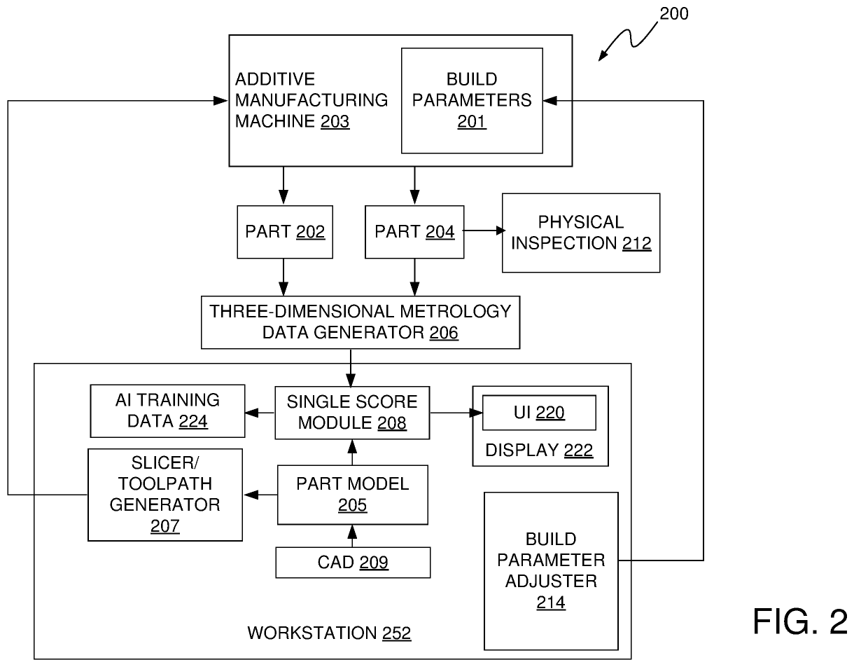

FIG. 1 provides a method for determining whether a part is accurate enough to send the part for physical inspection and/or is accurate enough to warrant building additional copies of the part. FIG. 2 provides a block diagram of a system 200 used to perform the method of FIG. 1.

In step 100 of FIG. 1, an additive manufacturing machine 203 uses a set of build parameters 201 and a part model 205 to build a part 202. In accordance with one embodiment, part model 205 is formed using a Computer-Aided Design (CAD) program 209 executed on a work station 252. Although a workstation 252 is described herein, those skilled in the art will recognize that any processing unit or set of processing units can be used in place of workstation 252. Part model 205 consists of a mesh of vertices that describe the three-dimensional geometry of the part. Part model 205 is sliced into layers and instructions for constructing each layer, sometimes referred to as toolpaths, are generated by a slicer and toolpath generator 207. The resulting toolpaths are provided to additive manufacturing machine 203, which uses the instructions and build parameters 201 to construct the part, slice-by-slice.

At step 102, a single score is determined for the part by a single score module 208 executing on workstation 252. In accordance with one embodiment, the single score is determined from three-dimensional metrology data generated from part 202 by a three-dimensional metrology data generator 206. Details of the generation of the single score are discussed below. At step 103, the single score is displayed in a user interface 220 on a display 222 of workstation 252. Examples of such user interfaces are discussed below.

At step 104, the single score is stored as part of Artificial Intelligence training data 224 so that the single score can be used later to train one or more artificial intelligence systems.

At step 106, a user determines if the displayed single score exceeds a threshold indicating that the part is of sufficient accuracy for some purpose. If the single score does not exceed the threshold, the user changes one or more of part model 205, build parameters 201, and the material used to construct the part at step 110. Part model 205 is modified using CAD 209 and build parameters 201 are modified using a build parameter adjuster program 214 executed on workstation 252. In accordance with one embodiment, the part model and or the build parameters are changed by a larger amount for scores that are further from the threshold than for scores that are closer to the threshold. A new part 204 is then built at step 100 using the new part model 205, new build parameters 201 and/or a new material. Steps 102, 103, 104 and 106 are then repeated for the new part. The process of building a part, generating a single score for the part, displaying the single score and changing one or more of the part model, the build parameters and the material are repeated until the single score exceeds the threshold. When a part is built that has a score that exceeds the threshold at step 106, the part is accurate enough to warrant sending the part for physical inspection 212 at step 108 or accepting the part and building additional copies of the part using the current part model 205 and the current build parameters 201 at step 109.

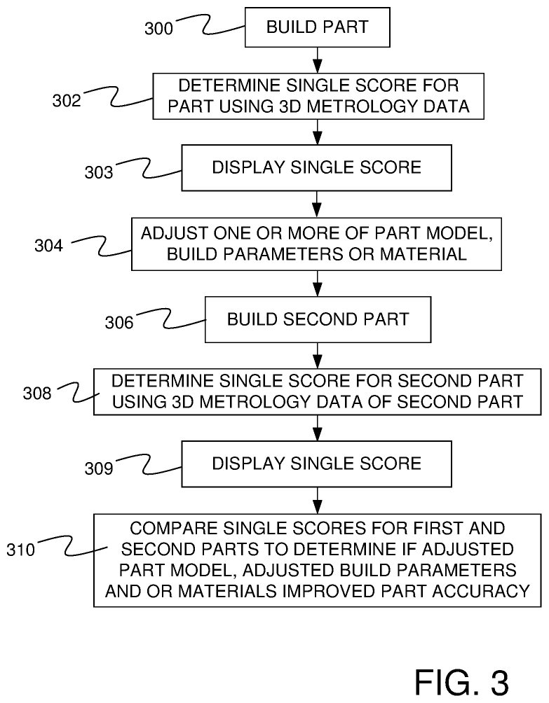

FIG. 3 provides a flow diagram of a method of determining if a change to build parameters, a part model and/or a material results in more accurate parts. At step 300, additive manufacturing machine 203 builds part 202 using part model 205 and build parameters 201. At step 302, a single score is determined for the part by single score module 208 executing on workstation 252. In accordance with one embodiment, the single score is determined from three-dimensional metrology data generated from part 202 by three-dimensional metrology data generator 206. Details of the generation of the single score are discussed below. At step 303, the single score is displayed on the user interface 220. At step 304, one or more of part model 205, build parameters 201 and the material used to form the part are adjusted. At step 306, additive manufacturing machine 203 builds a second part 204 using the new part model 205 and/or new build parameters 201 and/or new material.

A single score is determined at step 308 for second part 204 by single score module 208 executing on workstation 252. In accordance with one embodiment, the single score is determined in the same manner as in step 302 using three-dimensional metrology data generated from part 204 by three-dimensional metrology data generator 206. At step 309, the single score for second part 204 is displayed to the user on user interface 220. At step 310, the single scores for parts 202 and 204 are compared to each other to determine if adjusting the build parameters resulted in an improved part. In particular, if the score of second part 204 is greater than the score of first part 202, second part 204 is considered to have been built more accurately than first part 202. Thus, using a single score for each part, system 200 is able to quickly determine if adjustments to the build parameters improved production of the part.

Steps 304, 306, 308, 309 and 310 can be repeated any desired number of times until a part with a desired accuracy level is obtained where the accuracy level is based on the single score for the part.

Although FIGS. 1 and 3 use the score to determine whether a part is accurate enough to be sent for physical inspection, to warrant producing additional copies of the part and to determine if adjustments to build parameters improved production of a part, the score has other uses. For example, the score can be used to compare builds from the same machine over time to see if the machine or process performance is deteriorating; and to compare one machine or process to another.

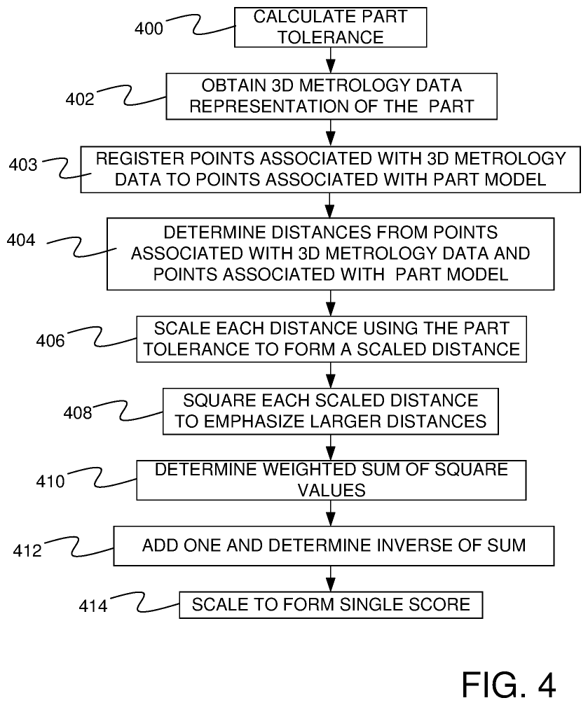

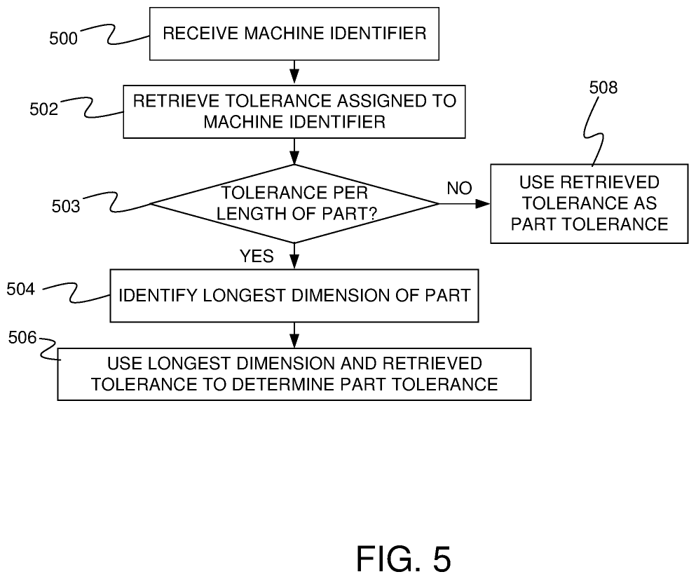

FIG. 4 provides a flow diagram of a method of determining a single score for a part as performed in any of steps 102, 302 and 308 above. In step 400, a part tolerance is calculated for the part. FIG. 5 provides a flow diagram of one method for calculating the part tolerance in step 400.

At step 500 of FIG. 5, the machine identifier for the machine used to construct the part is received. Examples of machine identifiers include the make and model of the machine, the layer height of the machine, the maximum size of parts that can be made with the machine, and the additive technology used by the machine to form the part, for example. In general, machines that manufacture larger parts or that apply larger layers when manufacturing parts tend to have larger tolerances.

At step 502, a tolerance assigned to the machine identifier is retrieved. This tolerance can either be a distance or as a distance per length of the part. For example, the tolerance could be defined as +/−0.002 inch per inch of the part. If the retrieved tolerance is defined as a distance per length of the part at step 503, a longest dimension of the part is identified at step 504. In accordance with one embodiment, the longest dimension of the part is determined from a CAD model of the part. At step 506, the longest dimension of the part and the retrieved tolerance per length of the part are used to determine the part tolerance. In accordance with one embodiment, the part tolerance is equal to the tolerance per inch of the part times the longest dimension of the part. This part tolerance is then used for the entire part and not just the longest dimension. If the tolerance is not a tolerance per length of the part at step 503, the retrieved tolerance is used as the part tolerance at step 508.

Returning to the flow diagram of FIG. 4, after the part tolerance has been calculated, three-dimensional metrology data of the part is obtained at step 402. The three-dimensional metrology data can be obtained directly from three-dimensional metrology data generator 206 or the three-dimensional metrology data can be stored in memory by three-dimensional metrology data 206 and then can be obtained from memory. In accordance with one embodiment, the three-dimensional metrology data is in the form of a point cloud that consists of a collection of three-dimensional vectors, where each vector indicates the location of a point on the surface of the part Three-dimensional metrology data generator 206 can include any known 3D metrology technology including Coordinate Measuring Machines (CMMs) with portable arms equipped with either fixed probe or etched trigger probe heads; Computed Tomography (CT) scanners; tracked 3D scanners; structured light 3D scanners; manual measurements and portable 3D scanners, for example. The number of points in three-dimensional metrology data can be selected based on a balance between the amount of part coverage desired and the desired operational speed of the system. More points in the three-dimensional metrology data will provide better coverage for the part but will take longer to process to produce the single score.

At step 403, points associated with the metrology data are registered with points associated with a stored model. The points associated with the metrology data can be points that are provided in the metrology data and/or points on surfaces constructed from points in the metrology data. Similarly, the corresponding points on the part model can be vertices that define the part model and/or points along surfaces defined by the vertices. The registration process produces a collection of point pairs with one point in each point pair being associated with the metrology data and one point in the point pair being associated with the model of the part. In each point pair, the point associated with the model is said to correspond to the point associated with the metrology data.

At step 404, the distance between the two points in each point pair is determined. to produce a plurality of distances. Thus, each distance is the distance between a point associated with the metrology data and a corresponding point associated with the part model.

At step 406, each of the distances is scaled using the part tolerance calculated in step 400 to form a scaled distance. In accordance with one embodiment, the scaling is performed by multiplying the distance by the inverse of the part tolerance. Note that the distance for a point can be either positive or negative. In general, the distance is positive if the point lies outside of the surface of the model and is negative if the point lies within the surface of the model.

At step 408, each scaled distance is squared to emphasize larger distances in the final single score. In particular, by taking the square, larger distances are magnified more than smaller distances causing larger distances to be emphasized more in the final single score. In other embodiments, instead of squaring the scaled distance, an absolute value of the scaled distance is determined to remove the sign of the distances.

Scaling each distance and taking the square of the scaled distance is the same as applying the distance to a function consisting of scaling and squaring to produce a function result. The embodiments are not limited to the function shown in FIG. 4 and other functions may be used in place of the scaling and squaring function shown in FIG. 4.

At step 410, a weighted sum of the squared values is determined across all points in the point cloud. By taking the weighted sum of the squared values, this embodiment provides a single score across the entire part representing the general build quality of the part. In accordance with some embodiments, negative distances are weighted differently from positive distances. In accordance with one embodiment, the weighted sum is an average that is determined by multiplying each squared value by a weight equal to one over the number of squared values. In accordance with still further embodiments, a mean of the squared values is determined in place of the weighted sum.

The weighted sum computed in step 410 increases with increasing distances between the points of the 3d scan and the model. In order to have a score that decreases with increasing distances, an inverse of the weighted sum is used in the various embodiments. However, as the weighted sum approaches zero, the inverse of the weighted sum becomes unstable and can tend toward infinity. To avoid this, at step 412, a value is added to the weighted sum to form a second sum and the inverse of the second sum is determined. In accordance with one embodiment, the value added to the weighted sum is one.

At step 414, the resulting inverse is scaled to form the single score. In accordance with one embodiment, the inverse is scaled by a value of one hundred to provide a possible score that ranges between zero and one hundred. However, other scaling values may be used instead of one hundred.

The method of FIG. 4 results in the formation of a single quality score, the Print Accuracy Score (PAS), according to the following equation:

$$PAS = 100 / ( 1 + {\sum }_{i = 1}^{Number of points} {{w}_{i} ( \frac{dist {ance}_{i}}{part tolerance} )}^{2} )$$

where wᵢ is a weight, which in one embodiment is set equal to one over the number of points so as to provide an average of the squared values.

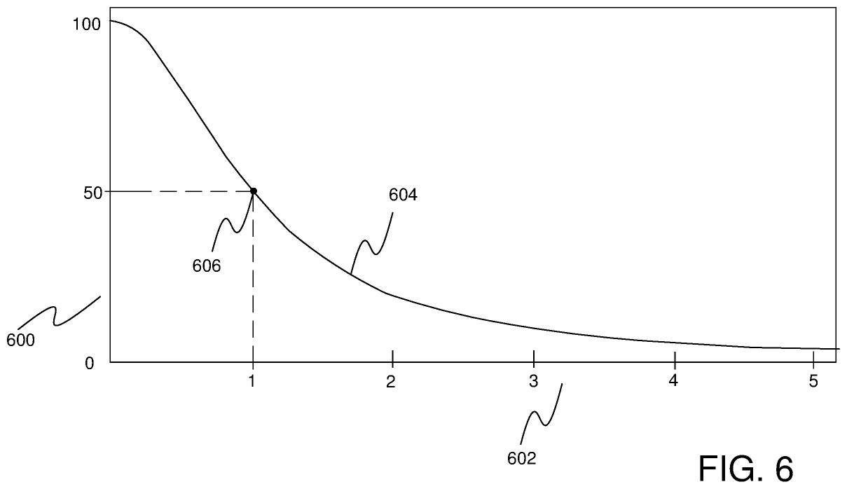

FIG. 6 shows a graph of the single score as a function of average point error divided by part tolerance. In FIG. 6, the single score is shown along vertical axis 600 and the average point error per part tolerance is shown along horizontal axis 602. As shown in FIG. 6, the single score is determined by a smooth function 604 that is differentiable and monotonical with respect to the average point error per part tolerance such that it always slopes downward and never goes to zero. An average error per part tolerance of 1 yields a score of 50 as indicated by point 606. For such a score, likely half of the points are outside the part tolerance.

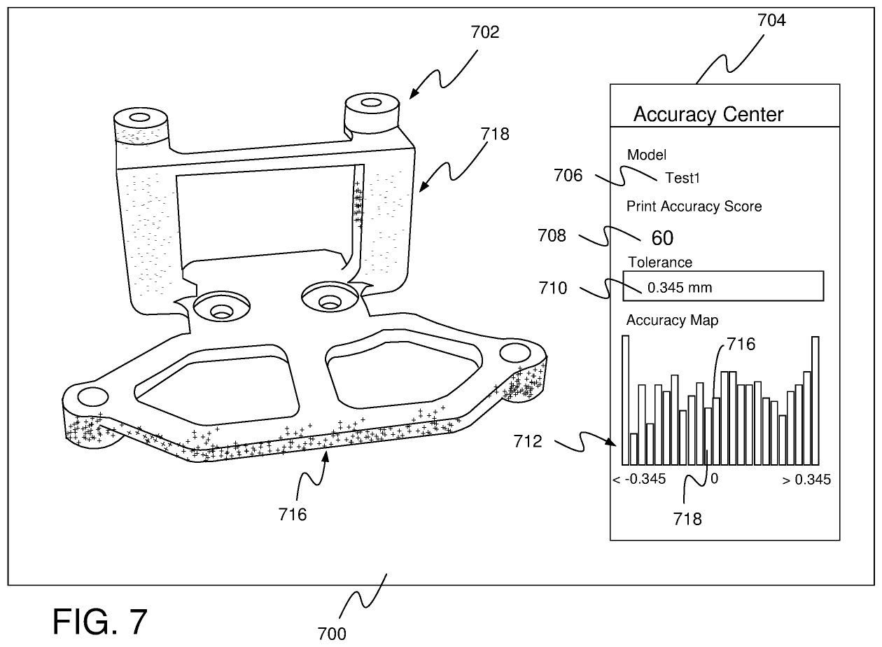

FIG. 7 provides an example of a user interface 700 for a first build of a part displayed in steps 103 and 303 of FIGS. 1 and 3, respectively. User interface 700 includes a three-dimensional rendering 702 of the part as determined from the three-dimensional metrology data generated by three-dimensional metrology data generator 206. User interface 700 also includes an accuracy center box 704 that provides accuracy information for the part depicted by rendering 702.

Accuracy center box 704 includes a part identifier 706, a print accuracy score 708 for the part, a tolerance 710, and an accuracy histogram 712 (referred to as an accuracy map in FIG. 7).

Part identifier 706 identifies which build of the part is associated with the accuracy information shown in accuracy center 704. Print accuracy score 708 is the print accuracy score determined for the identified part using the method of FIG. 4. Tolerance 710 is the value of the tolerance used in determining the print accuracy score as found in the equation above. The tolerance can be automatically set based on the machine used to form the part or can be manually set in tolerance box 710. If the tolerance is changed in box 710, the print accuracy score 708 is automatically recalculated using the new tolerance. Accuracy histogram 712 is a chart of the errors determined from the differences between the part model and the metrology data. In particular, accuracy histogram 712 provides a collection of bars, with a separate bar for each of a collection of error ranges. For example, one bar 716 is provided for errors from 0 to −0.0345 and another bar 718 is provided for errors from −0.0345 to −0.0690. The height of each bar represents the number of points that have an error that falls within the error range of the bar.

Three-dimensional rendering 702 is colored to show the location of the errors on the part. In accordance with one embodiment, points with a positive error are colored red with the shade of red becoming darker with increases in the size of the error. Such coloring is depicted in FIG. 7 with “+” signs, such as in area 716. In such embodiments, points with a negative error are colored blue with the shade of blue becoming darker with increases in the magnitude of the negative error. Such coloring is depicted in FIG. 7 with “−” signs, such as in area 718.

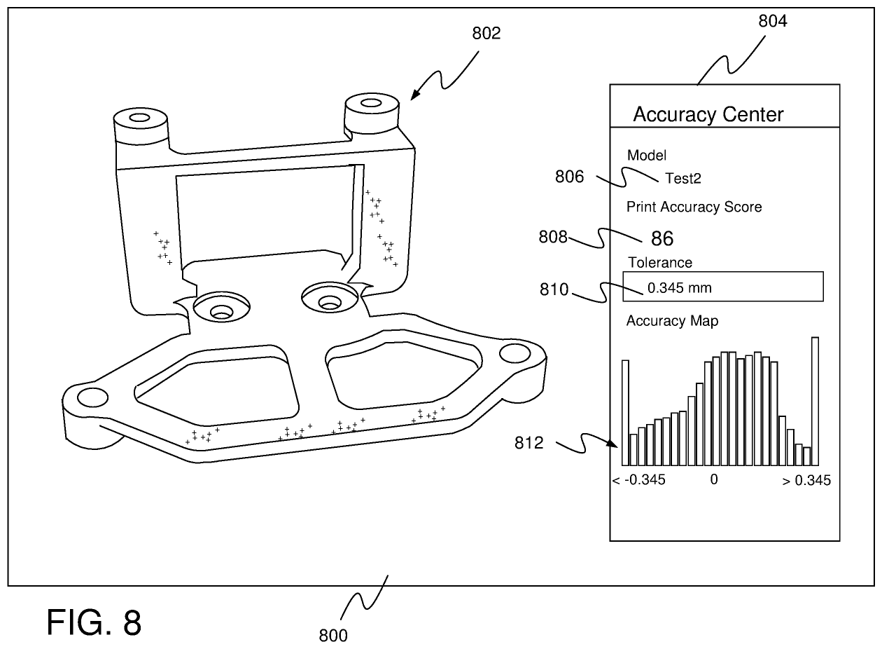

FIG. 8 provides an example of a user interface 800 for a second build of a part displayed in steps 103 and 309 of FIGS. 1 and 3, respectively. User interface 800 includes a three-dimensional rendering 802 of the second build of the part as determined from the three-dimensional metrology data generated by three-dimensional metrology data generator 206. User interface 800 also includes an accuracy center box 804 that provides accuracy information for the part depict by rendering 802.

Accuracy center box 804 includes a part identifier 806, a print accuracy score 808 for the second build of the part, a tolerance 810, and an accuracy histogram 812 (referred to as an accuracy map in FIG. 8).

Print accuracy score 808 is the print accuracy score determined for the second build of the part using the method of FIG. 4. Tolerance 810 is the value of the tolerance used in determining the print accuracy score as found in the equation above. The tolerance can be automatically set based on the machine used to form the part or can be manually set in tolerance box 810. If the tolerance is changed in box 810, the print accuracy score 808 is automatically recalculated using the new tolerance. Accuracy histogram 812 is a chart of the errors determined from the differences between the part model and the metrology data.

Three-dimensional rendering 802 is colored to show the location of the errors on the part. In accordance with one embodiment, points with a positive error are colored red with the shade of red becoming darker with increases in the size of the error. Such coloring is depicted in FIG. 8 with “+” signs. In such embodiments, points with a negative error are colored blue with the shade of blue becoming darker with increases in the magnitude of the negative error.

By comparing FIG. 8 to FIG. 7, it can be seen that the second build of the part has a higher print accuracy score—86 versus 60—and the shading on the three-dimensional renderings indicates that the second build of the part is more accurate than the first build of the part since there is less shading in FIG. 8 than in FIG. 7.

In the embodiments above, a single score was determined for an entire part. In other embodiments, the user may designate a portion of the part and limit the score to being determined for that portion of the part. This can be done to set the build parameters to improve the building of just a portion of the part rather than the entire part.

The embodiments described above can be used with a variety of different 3D printer technologies including, but not limited to:
Material extrusion—an additive manufacturing process in which material is selectively dispensed through a nozzle or orifice (also known as fused deposition modeling);
Material jetting—an additive manufacturing process in which droplets of build material are selectively deposited (also known as ink jetting);
Binder jetting—an additive manufacturing process in which a liquid bonding agent is selectively deposited to join powder materials;
Vat photopolymerization—an additive manufacturing process in which liquid photopolymer in a vat is selectively cured by light-activated polymerization (includes stereolithography and digital light curing processes);
Powder bed fusion—an additive manufacturing process in which thermal energy selectively fuses regions of a powder bed (includes selective laser sintering, high-speed sintering, and direct metal laser sintering); and
Directed energy deposition—an additive manufacturing process in which focused thermal energy is used to fuse materials by melting as they are being deposited.

In addition, the embodiments may be used with other manufacturing techniques.

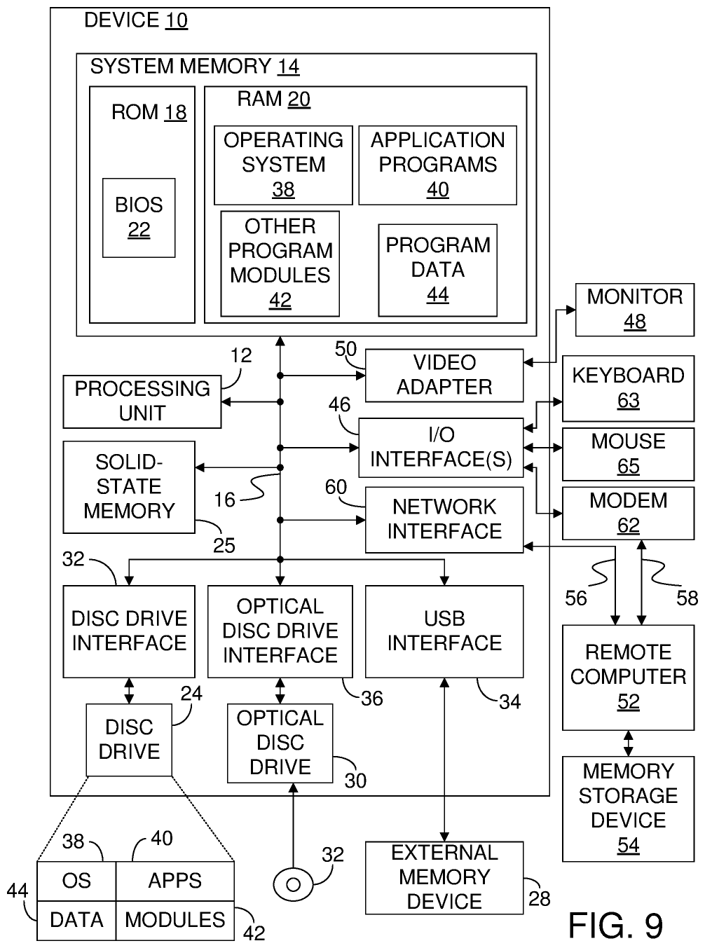

FIG. 9 provides an example of a computing device 10 that can be used to implement one or more of the workstations/computing devices discussed above. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 9. The network connections depicted in FIG. 9 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 9 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
determining a plurality of distances between representation of the part that is based on three-dimensional metrology data and a three-dimensional model of the part;
applying each distance to a function to produce a plurality of function results;
forming a single score from the plurality of function results;
displaying the single score
and performing at least one of comparing the single score to a single score of another part to determine whether changes made to a manufacturing process result in more accurate parts, determining whether the part is constructed accurately enough to warrant constructing additional copies of the part, or using the single score to determine whether the part is constructed accurately enough to warrant physical inspection.

2. The method of claim 1 wherein applying a distance to a function comprises scaling the distance based on a tolerance for the part to form a scaled distance.

3. The method of claim 2 wherein applying the distance to the function further comprises squaring the scaled distance.

4. The method of claim 3 wherein forming a single score from the plurality of function results comprises forming a weighted sum of the function results, adding one to the weighted sum to form a second sum, and multiplying the inverse of the second sum by a scaling value.

5. The method of claim 4 wherein forming the weighted sum comprises multiplying each function result by an inverse of a number of distances in the plurality of distances.

6. The method of claim 2 wherein the part is constructed through additive manufacturing and the tolerance is selected based on an identifier for the machine used to form the part.

7. The method of claim 5 wherein the tolerance is further based on a longest dimension of the part.

8. A method comprising:
obtaining three-dimensional metrology data from a part constructed using a model of the part, build parameters for the part and a material for the part;
registering a plurality of points determined from the three-dimensional metrology data to corresponding points of a model of the part;
for each point in the plurality of points determined from the three-dimensional metrology data, determining a distance from the point to the corresponding point on the model of the part;
scaling each distance based on a tolerance value for the part to produce a plurality of scaled values;
using the plurality of scaled values to produce a score for the part;
displaying the score for the part;
building a second part using a model for the second part, build parameters for the second part and a material for the second part wherein at least one of the model for the second part, the build parameters for the second part and the material for the second part is respectively different from the model of the part, the build parameters for the part and the material for the part;
obtaining three-dimensional metrology data from the second part;
registering a plurality of points determined from the three-dimensional metrology data for the second part to corresponding points of for the model of the second part;
for each point in the plurality of points determined from the three-dimensional metrology data for the second part, determining a distance from the point to the corresponding point on the model of the second part;
scaling each distance based on a tolerance value for the second part to produce a plurality of scaled values for the second part;
using the plurality of scaled values for the second part to produce a score for the second part; and
displaying the score for the part.

9. The method of claim 8 wherein using the plurality of scaled values to produce the score for the part comprises squaring the scaled values to produce squared values and using the squared values to produce the score for the part.

10. The method of claim 9 wherein using the squared values to produce the score for the part comprises determining a weighted sum of the squared values and using the weighted sum to produce the score for the part.

11. The method of claim 10 wherein forming the weighted sum comprises multiplying each squared value by an inverse of a number of points in the plurality of points.

12. The method of claim 8 wherein scaling the distance based on the tolerance value comprises scaling the distance by the inverse of the tolerance.

13. The method of claim 8 wherein the part is formed through additive manufacturing and the tolerance is dependent on an identifier for the machine used to manufacture the part.

14. The method of claim 8 wherein the tolerance is based on a longest dimension of the part.

15. A method comprising:
setting a tolerance for a part based on an identifier of a machine used to form the part;
obtaining three-dimensional metrology data from the part;
for each of a plurality of points associated with the three-dimensional metrology data, determining a distance between the point and an expected location for the point to produce a plurality of distances;
modifying each distance in the plurality of distances using the tolerance to form a plurality of modified distances;
using the modified distances to form an accuracy score for the part.

16. The method of claim 15 wherein setting the tolerance further comprises setting the tolerance based on a dimension of the part.

17. The method of claim 16 wherein the dimension of the part is the longest dimension of the part.

18. The method of claim 15 wherein modifying each distance comprises dividing each distance by the tolerance to form the modified distance.

19. The method of claim 15 further comprising using the accuracy score for the part and an accuracy score for a part made before changing parameters used by the machine to determine if changing the parameters improved the part.

20. The method of claim 15 further comprising using the accuracy score to determine if the part is accurate enough to warrant performing physical inspection of the part.
